(19) United States
(12) Patent Application Publication
(10) Pub. No.: US 2023/0011101 A1
(43) Pub. Date: Jan. 12, 2023

(54) RAPID SERVO PROFILE RECONFIGURATION IN A LiDAR SYSTEM

(71) Applicant: Seagate Technology LLC, Fremont, CA (US)

(72) Inventors: Eric James Dahlberg, Eden Prairie, MN (US); Raj Mahendra Jain, Minneapolis, MN (US)

(21) Appl. No.: 17/865,726

(22) Filed: Jul. 15, 2022

Related U.S. Application Data
(60) Provisional application No. 63/217,995, filed on Jul. 2, 2021.

(51) Int. Cl. G01S 7/481; G01S 17/931; G01S 17/89

(52) U.S. Cl. CPC G01S 7/4817; G01S 17/931; G01S 17/89

(57) ABSTRACT

Method and apparatus for reconfiguring a light detection and ranging (LiDAR) system based on detected changes in environmental conditions. In some embodiments, an illumination profile is generated to identify a portion of a field of view (FoV) to which enhanced electromagnetic radiation is to be applied by an emitter of the LiDAR system. A scan profile is generated corresponding to the illumination profile, and the scan profile is applied to an output device of the emitter to produce the selected illumination profile upon targets in the FoV. The scan profile is generated in response to an external sensor that indicates a change in operational environment for the LiDAR system, such as a geopositioning sensor that detects a change in elevation or direction of a vehicle in which the LiDAR system is mounted. An observer and plant model can be incorporated into a servo control system to direct the scanning patterns.

### RELATED APPLICATION

The present application makes a claim of domestic priority to U.S. Provisional Patent Application No. 63/217,995 filed Jul. 2, 2021, the contents of which are hereby incorporated by reference.

### SUMMARY

Various embodiments of the present disclosure are generally directed to a method and apparatus for adaptively adjusting a resolution of a field of view (FoV) of a light detection and ranging (LiDAR) system.

Without limitation, some embodiments operate to generate an illumination profile identify a portion of a field of view (FoV) to which enhanced electromagnetic radiation is to be applied by an emitter of the LiDAR system. A scan profile is generated corresponding to the illumination profile, and the scan profile is applied to an output device of the emitter to produce the selected illumination profile upon targets in the FoV. The scan profile is generated in response to an external sensor that indicates a change in operational environment for the LiDAR system, such as a geopositioning sensor that detects a change in elevation or direction of a vehicle in which the LiDAR system is mounted. An observer and plant model can be incorporated into a servo control system to direct the scanning patterns.

These and other features and advantages of various embodiments can be understood from a review of the following detailed description in conjunction with the accompanying drawings.

### BRIEF DESCRIPTION OF THE DRAWINGS

FIG. 1 is a block representation of a Light Detection and Ranging (LiDAR) system constructed and operated in accordance with various embodiments of the present disclosure.

FIG. 2 is a simplified functional representation of an emitter constructed and operated in accordance with some embodiments.

FIGS. 3A, 3B and 3C show different output systems that can be incorporated into an emitter such as in FIG. 2.

FIG. 4 is a simplified functional representation of a detector constructed and operated in accordance with some embodiments.

FIG. 5 depicts a field of view (FoV) of the system in some embodiments.

FIG. 6 shows different scan densities that can be applied to a FoV such as in FIG. 5 in some embodiments.

FIG. 7 is a functional block representation of the system in some embodiments in which selected regions of interest are identified and adjustments are made accordingly.

FIGS. 8A and 8B show different FoVs having different beam point densities generated in accordance with various embodiments.

FIG. 9 shows a closed loop servo control system utilized by various embodiments to provide FoVs such as illustrated in FIGS. 8A-8B.

FIG. 10 is a pulse transmission and decoding sequence carried out in accordance with some embodiments.

FIG. 11 shows a beam point density adjustment sequence carried out in accordance with some embodiments.

FIG. 12 shows a scan window management system constructed and operated in accordance with further embodiments.

### DETAILED DESCRIPTION

Various embodiments of the present disclosure are generally directed to systems and methods for optimizing performance of an active light detection system.

Light Detection and Ranging (LiDAR) systems are useful in a number of applications in which range information (e.g., distance, etc.) associated with a target is determined by irradiating the target with electromagnetic radiation. One increasingly popular application for LiDAR is in the area of autonomously piloted or driver assisted vehicle guidance systems (e.g., self driving cars, autonomous drones, etc.). While not limiting, the light wavelengths used in a typical LiDAR system may range from ultraviolet to near infrared (e.g., 250 nanometers, nm to 1500 nm or more). Other wavelength ranges can be used.

One commonly employed form of LiDAR is sometimes referred to as coherent pulsed LiDAR, which generally uses coherent light and detects the range based on detecting phase differences in the reflected light. Such systems may use a dual (I/Q) channel detector with an I (in-phase) channel and a Q (quadrature) channel. Other forms of LiDAR systems can be used, however, including non-coherent light systems that may incorporate one or more detection channels. Further alternatives that can be incorporated into LiDAR systems include systems that sweep the emitted light using mechanical based systems such as rotatable mirrored polygons or micromirrors that utilize moveable mechanical elements, solid-state systems with no moving mechanical parts but instead use phase array mechanisms to sweep the emitted light in a direction toward the target, and so on.

While operable, these and other forms of LiDAR systems can have difficulty providing accurate detection resolution in all desired areas under all operating conditions. In particular, it may be desirable at times to provide enhanced detection to particular regions of interest within a particular field of view (FoV) of the system.

Various embodiments of the present disclosure are accordingly directed to a method and apparatus for providing enhanced detection capabilities in a LiDAR system. As explained below, some embodiments provide a closed loop servo control system that operates such that different areas of interest within a FoV of the system are adjusted to have different emitted beam point densities using different settings to account for different operational environments.

Operational environments that can be processed by various embodiments can include, but are not limited to, the following: (1) modeling vertical curvature of a road to set a vertical offset; (2) adjustments in vertical foveation based on limited point on area of interest; (3) selective focus once particular targets are identified (including object permanence, occupancy grid and other techniques); (4) horizontal resolution adjustments based on rotational velocity sensing (such as providing higher resolution to the path of a vehicle around a curve); (5) intersectional detection and enhanced sensing in side directions; (6) frame-to-frame foveation changes; (7) foveation changes based on road markings and other indicators; (8) minimum safe sample resolutions; (9) map integration operations; (10) vertical resolution changes based on system angle (such as during changes in elevation); and (11) setting different vertical (or other axial) spacing of LiDAR scanlines based on scan inputs and plant modeling. Other operational environments can be processed as well to provide optimal beam point densities for the system.

In further embodiments, the separation of beam scanlines is determined based on the scanning profile of an actuated mirror or other output directing device and thus the scanning profile directly impacts the resolution and its distribution for the LiDAR. The resolution across the scan can be optimized for regions of interest in the sensors field of view. Regions of interest may change position from frame to frame so it may be desirable for the servo system to quickly adjust to changing scanning profiles which may be non-linear.

The disclosed system and method make use of a feedforward system for tracking the profile using various servo techniques including plant inversion. The feedforward servo control system can include a plant model that models the response of the system and an observer module that observes and predicts the operation of the plant to provide inputs to obtain adjustments to provide suitable closed loop tracking of desired trajectories. In this way, system inputs, including inputs from external sensors, can be adaptively used to enact servo tracking modes automatically that provide the desired increases or decreases in system resolution during operation.

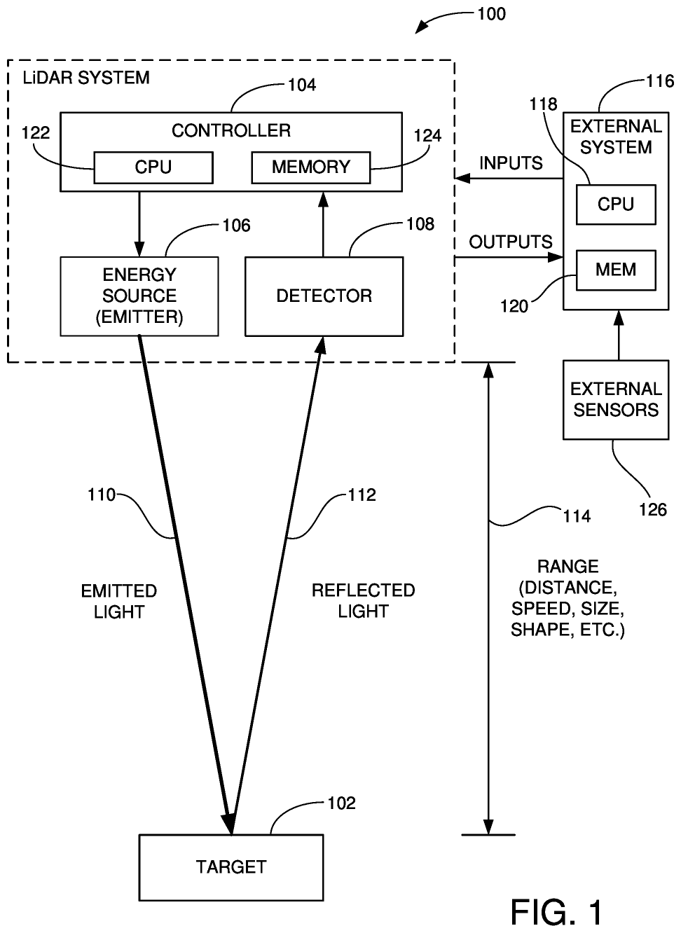

These and other features and advantages of various embodiments can be understood beginning with a review of FIG. 1 which provides a simplified functional representation of a LiDAR system 100 constructed and operated in accordance with various embodiments of the present disclosure.

The LiDAR system 100 is configured to obtain range information regarding a target 102 that is located distal from the system 100. The information can be beneficial for a number of areas and applications including, but not limited to, topography, archeology, geology, surveying, geography, forestry, seismology, atmospheric physics, laser guidance, automated driving and guidance systems, closed-loop control systems, etc.

The LiDAR system 100 includes a controller 104 which provides top level control of the system. The controller 104 can take any number of desired configurations, including hardware and/or software. In some cases, the controller 104 can include the use of one or more programmable processors with associated programming (e.g., software, firmware) stored in a local memory which provides instructions that are executed by the programmable processor(s) during operation. Other forms of controllers can be used, including hardware based controllers, digital signal processors (DSPs), field programmable gate arrays (FPGAs), system on chip (SOC) integrated circuits, application specific integrated circuits (ASICs), gate logic, reduced instruction set computers (RISCs), etc.

An energy source circuit 106, also sometimes referred to as an emitter or a transmitter, operates to direct electromagnetic radiation in the form of light pulses toward the target 102. A detector circuit 108, also sometimes referred to as a receiver or a sensor, senses reflected light pulses received back from the target 102. The controller 104 directs operation of the emitted light from the emitter 106, denoted by arrow 110, and decodes information from the reflected light obtained back from the target, as denoted by arrow 112.

Arrow 114 depicts the actual, true range information associated with the intervening distance (or other range parameter) between the LiDAR system 100 and the target 102. Depending on the configuration of the system, the range information can include the relative or absolute speed, velocity, acceleration, distance, size, location, reflectivity, color, surface features and/or other characteristics of the target 102 with respect to the system 100.

The decoded range information can be used to carry out any number of useful operations, such as controlling a motion, input or response of an autonomous vehicle, generating a topographical map, recording data into a data structure for further analysis and/or operations, etc. The controller 104 perform these operations directly, or can communicate the range information to an external system 116 for further processing and/or use.

In some cases, inputs supplied by the external system 116 can activate and configure the system to capture particular range information, which is then returned to the external system 116 by the controller 104. The external system can take any number of suitable forms, and may include a system controller (such as CPU 118), local memory 120, data storage device, etc. The external system may form a portion of a closed-loop control system and the range information output by the LiDAR system 100 can be used by the external system 116 to adjust the position of a moveable element.

The controller 104 can incorporate one or more programmable processors (CPU) 122 that execute program instructions in the form of software/firmware stored in a local memory 124, and which communicate with the external controller 118. External sensors 126 can provide further inputs used by the external system 116 and/or the LiDAR system 100.

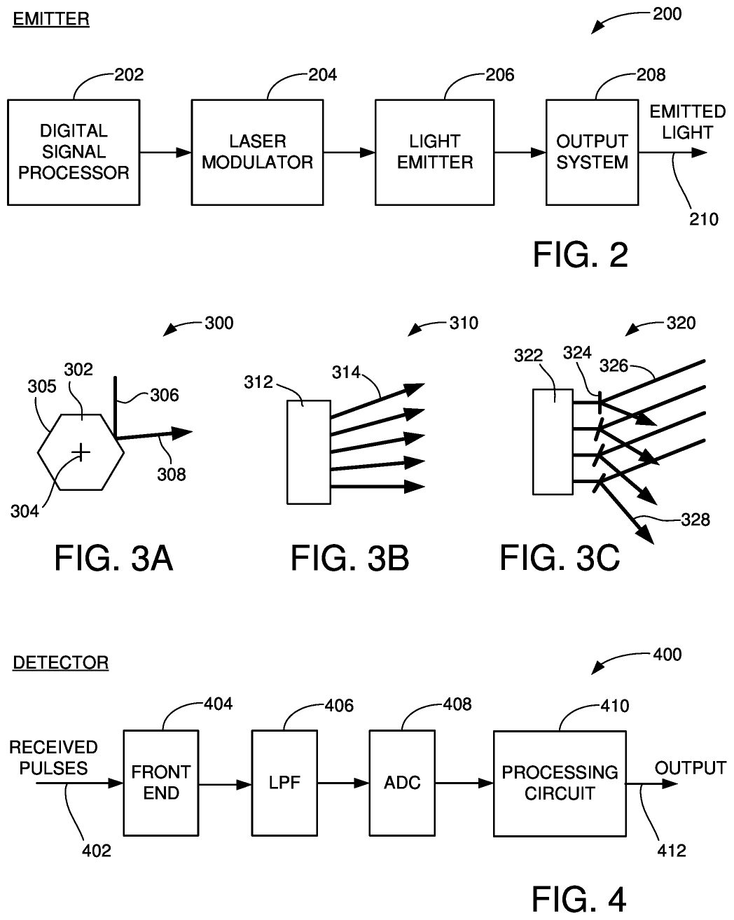

FIG. 2 depicts an emitter circuit 200 that can be incorporated into the system 100 of FIG. 1 in some embodiments. Other arrangements can be used so the configuration of FIG. 2 is merely illustrative and is not limiting. The emitter circuit 200 is shown to include a digital signal processor (DSP) that provides adjusted inputs to a laser modulator 204, which in turn adjusts a light emitter (e.g., a laser, a laser diode, etc.) that emits electromagnetic radiation (e.g. light) in a desired spectrum.

The emitted light is processed by an output system 208 to issue a beam of emitted light 210. The light may be in the form of pulses, coherent light, non-coherent light, swept light, etc. The light can be issued in a rasterized pattern to provide frames of data. In some cases, the emitted and decoded light enable the controller to generate a three-dimensional (3D) point map or cloud representation of the surrounding environment within the field of view (FoV) of the system.

FIGS. 3A-3C show different aspects of some forms of output systems that can be used by the system of FIG. 2. Other arrangements can be used. FIG. 3A shows a system 300 that includes a rotatable polygon 302 which is mechanically rotated about a central axis 304 at a desired rotational rate. The polygon 302 has reflective outer surfaces 305 adapted to direct incident light 306 as a reflected stream 308 at a selected angle responsive to the rotational orientation of the polygon 302. The polygon is characterized as a hexagon with six reflective sides, but any number of different configurations can be used. By coordinating the impingement of light 306 and rotational angle of the polygon 302, the output light 308 can be swept across a desired FoV.

FIG. 3B provides a system 310 with a solid state array (integrated circuit device) 312 configured to emit light beams 314 at various selected angles across a desired FoV. Unlike the mechanical system of FIG. 3A, the solid state system of FIG. 3B has essentially no moving parts. Instead, solid-state semiconductor elements are used to sweep the emitted light beams across the FoV.

FIG. 3C shows another system 320 that employs a base substrate 322 that supports an array of micromirrors 324. Piezoelectric or other mechanisms can be used to deflect the micromirrors 324 and change an angle between incident light 326 and reflected light 328. Other mechanisms can be employed as desired, including galvanometers (galvos) that operate to deflect or otherwise move refractive optical elements (e.g., lenses, etc.).

Regardless the configuration of the output system, FIG. 4 provides a generalized representation of a detector circuit 400 configured to process reflected light issued by the system of FIG. 2. The detector circuit 400 receives reflected pulses 402 which are processed by a suitable front end 404. The front end 404 can include optics, detector grids, CCDs (charge-coupled devices), amplifiers, mixers, and other suitable features to present input pulses reflected from the target. The particular configuration of the front end 404 is not germane to the present discussion, and so further details have not been included. It will be appreciated that multiple input detection channels can be utilized.

A low pass filter (LPF) 406 and an analog to digital converter (ADC) 408 can be used as desired to provide processing of the input pulses. A processing circuit 410 provides suitable signal processing operations to generate a useful output 412. Coherent and non-coherent detection strategies can be implemented as desired.

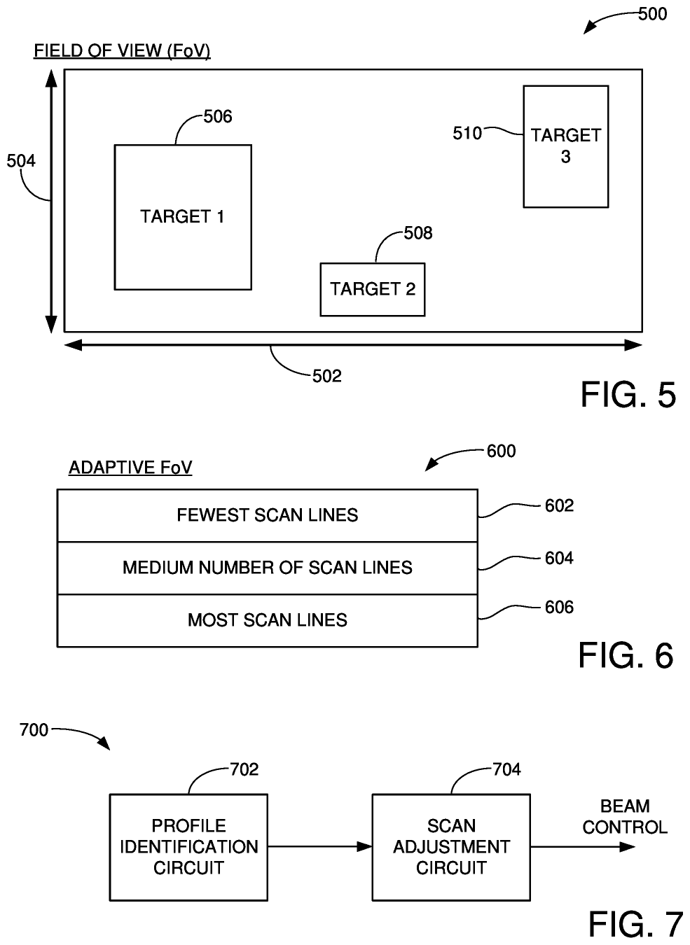

FIG. 5 shows a field of view (FoV) that may be represented as that portion of down range space that is accessed by the system 100. As explained below, various embodiments provide adjustment capabilities to adjust scans along various orthogonal directions, such as a horizontal direction 502 and a vertical direction 504. Different coordinate and spatial dimensions can be used depending on the configuration of the system apart from the x-y coordinate system shown in FIG. 5 including but not limited to polar coordinates, etc.

Various targets may be detected within the FoV 500 such as represented by targets 506, 508 and 510 (denoted as Targets 1-3). The targets are detected responsive to the reflected light provided by the emitter (e.g., FIG. 2) and received by the detector (e.g., FIG. 4).

In some cases, it may be desirable to not provide a consistent scanning density across the entirety of the FoV 500. Instead, it may be desirable to provide enhanced scans in different regions of interest. A number of different circumstances and system inputs can be provided to determine at such times when the focusing of the energy by the system is directed with greater intensity or other measure to portions of the FoV, while spending less of the overall available energy on other portions of the FoV.

For example, in the context of an automobile with LiDAR capabilities, it may make sense as the car goes down a hill to focus more of the expended electromagnetic radiation (e.g., scan lines, scan resolution, pulses, etc.) on targets that may be at a lower elevation than the car (as opposed to scanning the sky), on the basis that targets of interest will more likely be in lower portions of the FoV.

Similarly, if the same automobile is climbing a hill, it would make sense to focus more of the expended electromagnetic radiation on targets that are elevationally higher than the car on the basis that as the car climbs the hill, targets of interest will tend to be in the upper portions of the FoV. Other use cases can be envisioned that might make other regions of interest (for example, if the automobile is sensed as making a left-handed turn, targets to the left in the FoV may be of more interest, etc.).

As noted above, a variety of different mechanisms are envisioned in the present disclosure to compensate for these and other aspects. These can include modeling or other analytical aspects to determine appropriate scanning features of the light over the FoV. The operational modes that can be implemented under different circumstances to account for operational environments include but not limited to the following: (1) modeling vertical curvature of a road to set a vertical offset; (2) adjustments in vertical foveation based on limited point on area of interest; (3) selective focus once particular targets are identified (including object permanence, occupancy grid and other techniques); (4) horizontal resolution adjustments based on rotational velocity sensing (such as providing higher resolution to the path of a vehicle around a curve); (5) intersectional detection and enhanced sensing in side directions; (6) frame-to-frame foveation changes; (7) foveation changes based on road markings and other indicators; (8) minimum safe sample resolutions; (9) map integration operations; (10) vertical resolution changes based on system angle (such as during changes in elevation); and (11) setting different vertical (or other axial) spacing of LiDAR scanlines based on scan inputs and plant modeling.

Other operational environments can be processed as well to provide optimal beam point densities for the system. Some embodiments can account for all of these listed operational environments, while other embodiments may focus on only a single one or a subset of these (or other) environments.

FIG. 6 is an example FoV 600 similar to the FoV 500 in which different vertical scan line densities are supplied based on detected conditions. In this nonlimiting example, a first region 602 has a fewest number of scan lines, an intermediate region 604 has a larger number of scan lines and a lowest region 606 has a highest number of scan lines. Accordingly, the system has determined that targets of interest are most likely located toward the bottommost portion of the FoV 600, and so more electromagnetic radiation, in the form of more pulses, more raster scans, more dense scans, etc. are supplied to this portion of the FoV. Other arrangements can be used based on the factors above.

FIG. 7 is a processing circuit 700 of the various embodiments and can be incorporated into the various systems described above. The circuit 700 includes a profile identification circuit 702, which operates to determine a suitable non-uniform profile for the application of the electromagnetic radiation across the available FoV. From circuit 702, inputs are supplied to a scan adjustment circuit 704 which operates, such as through control of the output elements in FIGS. 3A-3C, to carry out the desired non-uniform application of the light to provide the desired detection focusing and response.

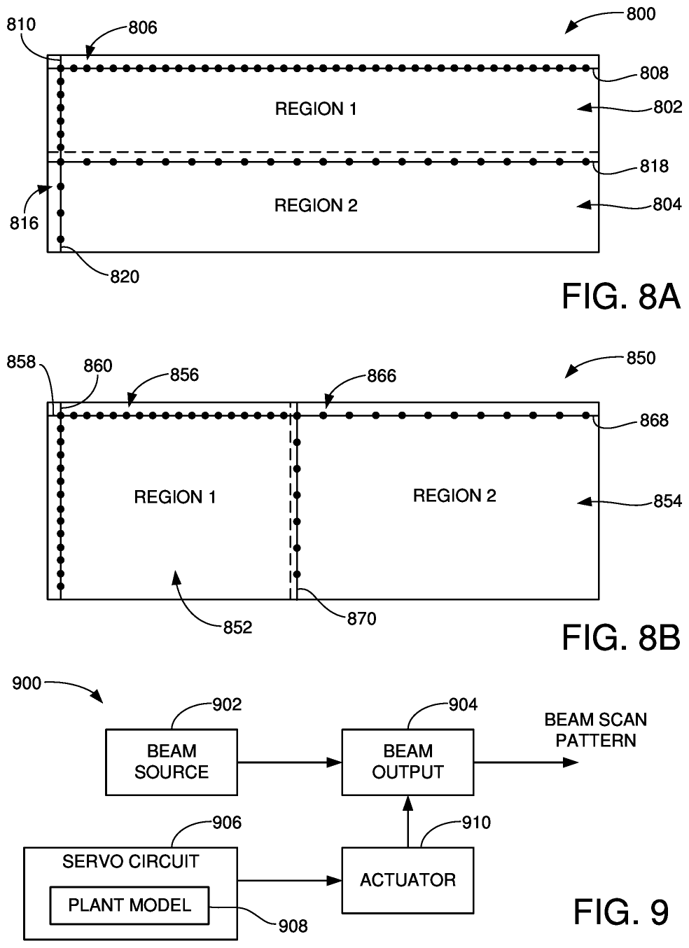

FIG. 8 shows another FoV 800 generated in accordance with some embodiments. The FoV 800 is divided into two regions 802 and 804, each having a different resolution (beam point density). The beam point density differences between regions 802 and 804 can be carried out in a number of ways, including but not limited to providing different sized and spacing of beams, different number of rasterized rows and columns (or other scanning pattern arrangements), different frame rates, etc.

The first region (Region 1) 802 is scanned using beam points 806 that are arranged (rasterized) along orthogonal x (horizontal) and y (vertical) axes as indicated by rows 808 and columns 810. Region 1 generally occupies the upper half of the overall FoV 800, although the respective sizes of the respective regions can vary as desired (e.g., Region 1 can occupy the top quarter of the FoV, the top two-thirds of the FoV, etc.).

The beams 806 are continuously and repetitively scanned using a suitable rasterization pattern over each frame so that all of the area of the region is covered by the scan points 806 in each frame. In some cases, a horizontal pattern is used (e.g. each row 806 is scanned in turn); in other cases, a vertical pattern is used (e.g., each column 810 is scanned in turn); in still other cases, a serpentine or other scan pattern is used. As will be recognized, the scanning of each frame within Region 1 is provided many times per unit of time (e.g., many thousands or millions of frames per second or more) to detect and track targets (see FIG. 5) detected within the region based on the reflected light from such targets (see FIG. 4).

The second region 804, denoted as Region 2, similarly receives a rasterized scanning pattern of beam points 816. The beams 816 may be nominally the same as the beams 806, or may have different waveform characteristics. As before, the beams 816 are rasterized along orthogonal x-y axes indicated by rows 818 and columns 820. In some cases, one rasterizing pattern is applied to Region 1 (e.g., on a per-row basis) and a different rasterizing pattern is applied to Region 2 (e.g., on a per-column basis). The overall density of the scanning pattern of Region 2 is lower than the density of the scanning pattern of region 1. This change in density can be accomplished in a number of ways, including by the use of a lower frame rate, a different number of beam points per row/column, a lower amplitude of the respective pulses, etc. as desired.

Regardless, it will be understood from FIG. 8A that generally, more of the available energy from the emitter is directed to Region 1 as compared to Region 2. This is true whether the emitter has a single source or multiple sources; overall, more energy is directed to the first region as compared to the second region. The actual percentage difference will vary, and can vary over time based on system inputs. In one non-limiting example, ⅔ of the overall energy is supplied to Region 1 and ⅓ of the overall energy is supplied to Region 2. Other ratios can be used as desired (e.g., 90% of the energy can be supplied to Region 1 and only 10% of the energy can be supplied to Region 2, and so on.).

The basis for the division between Region 1 and Region 2 in FIG. 8A can come about based on a number of different factors. In one embodiment, external sensors can detect that the system (such as in a vehicle) is increasing in elevation such as through the use of geopositioning (GPS) sensors, accelerometers, etc., and as a result, the system determines that the upper portion of the FoV 800 will likely provide more important information for the system, and hence, greater density is applied to this region. Other environmental systems can result in the preference shown in FIG. 8A, however, such as but not limited to the detected absolute or relative velocity of the system (e.g., detecting highway speeds may result in a desire to scan for targets within the upper portion of the FoV, etc.).

FIG. 8B shows another FoV 850 that can be configured in accordance with further embodiments. In this case, the FoV 850 is again divided into two regions 852 and 854 (Regions 1 and 2), but in this case, the left-hand side of the FoV 850 (Region 1) receives a greater energy density as compared to the right-hand side of the FoV 850 (Region 2). While not limiting, this may arise under various detected environmental conditions based on external sensors, such as but not limited to the detection of an intersection, the detection of the geoposition of a vehicle carrying the system in changing direction (such as by turning left), the presence of a construction site or oncoming traffic in an adjacent lane next to the vehicle, and so on.

The Region 1 area 852 is rasterized using beam points 856 which, as before, are arranged along orthogonal axes such as x-y Cartesian axes provided by rows 858 and columns 860. The Region 2 area 854 is similarly rasterized using beam points 866 arranged along rows 868 and columns 870. The rows and columns in the respective regions may be aligned or may be offset as required. As before, Region 1 has a significantly greater beam density as compared to Region 2.

While FIGS. 8A and 8B show just two respective regions of interest (e.g., a baseline Region 2 and an enhanced Region 1), it will be understood that other configurations can be provided, including but not limited to multiple regions with various different densities as described above including in FIG. 6.

FIG. 9 depicts a control circuit 900 implemented in the various systems described above in some embodiments. The circuit 900 includes a beam source 902 which can be one or more laser diodes or other sources of electromagnetic radiation. The output from the source 902 is directed to and steered by a beam output device 904, which as described above may take a mechanical or solid-state configuration such as but not limited to the various structures described above in FIGS. 3A-3C.

A closed loop servo control circuit 906 operates in at least some embodiments using a plant model 906 to provide inputs to an actuator 910, which in turn electrically and/or mechanically operates upon the beam output device 904 to direct the output beam scan pattern for the various FoV regions such as represented in FIGS. 8A and 8B. The plant model 906 can be realized in hardware or software by a controller such as 104 in FIG. 1, and models the response characteristics of the system as will be recognized by those skilled in the art of closed loop positional control systems. In this way, the servo control circuit 906 can operate to very precisely direct the beams to the respective areas and adaptively change these regions quickly under different operational conditions.

In some cases, the system can be arranged to provide a baseline scan operation over an overall FoV. Based on detected environmental conditions, an illumination profile can be identified to identify an area in which enhanced density scanning should be applied (e.g., such as the respective Region 1 areas in FIGS. 8A and 8B).

In response to this illumination profile, the servo control circuit can operate to generate and output a corresponding scan profile, which is then used to direct the beam to provide the enhanced scan resolution to the region of interest.

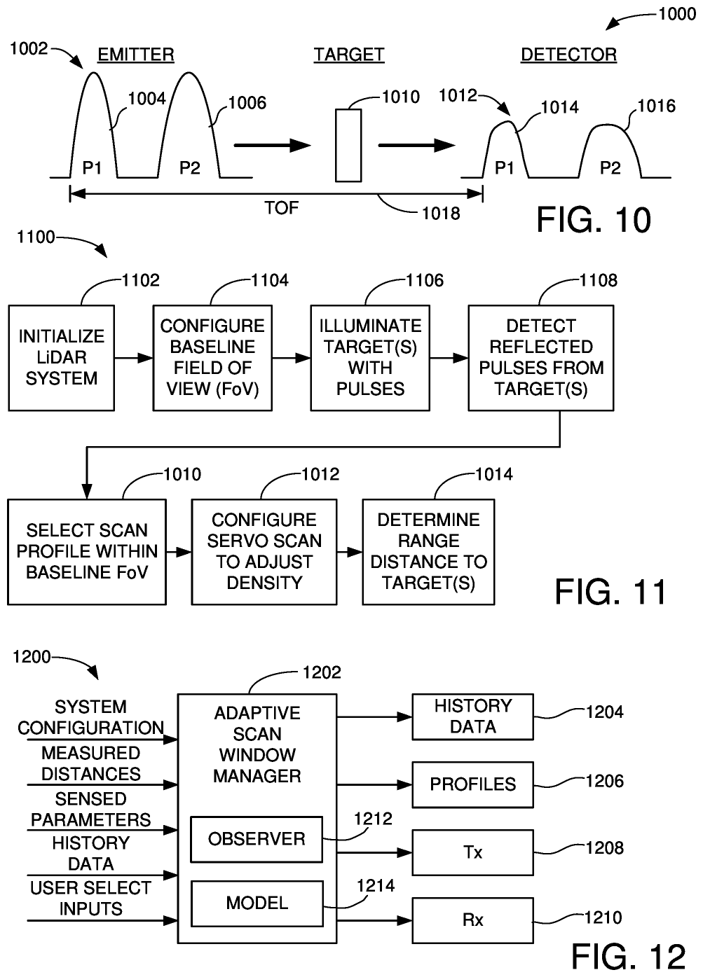

FIG. 10 depicts a pulse transmission and reflection sequence 1000 carried out in accordance with various embodiments. An initial set of pulses is depicted at 1002 having two pulses 1004, 1006 denoted as P1 and P2. Each pulse may be provided with a different associated frequency or have other characteristics to enable differentiation by the system. The emitted pulses 1004, 1006 are quanta of electromagnetic energy that are transmitted downrange toward a target 1010.

Reflected from the target is a received set of pulses 1012 including pulses 1014 (pulse P1) and 1016 (pulse P2). The time of flight (TOF) value for pulse P1 is denoted at 1018. Similar TOF values are provided for each pulse in turn.

The received P1 pulse 1014 will likely undergo frequency doppler shifting and other distortions as compared to the emitted P1 pulse 1004. The same is generally true for each successive sets of transmitted and received pulses such as the P2 pulses 1006, 1016. Nevertheless, the frequencies, phase and amplitudes of the received pulses 1014, 1016 will be processed as described above to enable the detector circuit to correctly match the respective pulses and obtain accurate distance and other range information.

In some cases, the emitted/received pulses such as P1 can represent the higher resolution pulses submitted to a first field (e.g., Region 1 in FIGS. 8A-8B), and the emitted/received pulses such as P2 can represent the lower resolution pulses in a second field (e.g., Region 2 in FIGS. 8A-8B). It will be appreciated that the pulses sent to the respective regions may be interleaved, or all of the pulses to one region (e.g. Region 1) may be sent as a first frame followed by all of the pulses to another region (e.g., Region 2). Different frequencies, wavelengths, amplitudes, gain characteristics, pulse sequence counts, and other adjustments can be made to distinguish and process the respective pulses in the various areas.

FIG. 11 is a sequence diagram 1100 for an enhanced resolution scan operation carried out in accordance with various embodiments described herein. Other operational steps can be incorporated into the sequence as required, so the diagram is merely illustrative and is not limiting.

A LiDAR system such as 100 in FIG. 1 is initialized at block 1102. An initial, baseline field of view (FoV) is selected for processing at block 1104. This will include selection and implementation of various parameters (e.g., pulse width, wavelength, raster scan information, density, etc.) to accommodate the baseline FoV.

Thereafter the system commences with normal operation at block 1106. Light pulses are transmitted to illuminate various targets within the FoV as described above using the emitters as variously described above. Reflected pulses from various targets within the baseline FoV are detected at block 1108 using a detector system as provided including at FIGS. 1 and 4; see also FIG. 9.

An area of interest within the baseline FoV is next selected at 1010. This can be carried out based on a number of inputs, including range information obtained from 1108, external sensor information, user input, etc. Regardless, a particular field of interest is identified to receive enhanced scanning resolution. In response, the servo system (e.g., FIG. 9) operates to direct beams at the selected area at an enhanced resolution, such as described above, as shown by block 1012. Range information for targets detected within the enhanced area is obtained during block 1014.

As noted above, the system can cycle to provide different scanning patterns for different areas as required. FIG. 12 shows an adaptive management system 1200 that can be incorporated into the system 100 of FIG. 1 in some embodiments. The system 1200 includes an adaptive scan window manager circuit 1202 which operates to implement the enhanced resolution scans in the selected fields of interest within a baseline FoV as described above. The manager circuit 1202 can be incorporated into the controller 104 such as a firmware routine stored in the local memory 124 and executed by the controller processor 122.

The manager circuit 1202 uses a number of inputs including system configuration information, measured distance for various targets, various other sensed parameters from the system (including external sensors 126), history data accumulated during prior operation, and user selectable inputs. Other inputs can be used as desired.

The manager circuit 1202 uses these and other inputs to provide various outputs including accumulated history data 1204 and various profiles 1206, both of which can be stored in local memory such as 124 for future reference. The history data 1204 can be arranged as a data structure providing relevant history and system configuration information. The profiles 1206 can describe different pulse set configurations with different numbers of pulses at various frequencies and other configuration settings, as well as other appropriate gain levels, ranges and slopes for different sizes, types, distances and velocities of detected targets.

The manager circuit 1202 further operates to direct various control information to an emitter (transmitter Tx) 1208 and a detector (receiver Rx) 1210 to implement these respective profiles. It will be understood that the Tx and Rx 1208, 1210 correspond to the various emitters and detectors described above. Without limitation, the inputs to the Tx 1208 can alter the pulses being emitted in the area of interest (including actuation signals to selectively switch in the specially configured lens or other optical element), and the inputs to the Rx 1210 can include gain, timing and other information to equip the detector to properly decode the pulses from the enhanced resolution area of interest.

The adaptive scan window manager 1202 can include an observer 1212 that provides observed or estimated positions of the scanning element which is modeled by model 1214. In this way, closed loop servo control can be adaptively and effectively implemented to accommodate rapidly changing detected environmental conditions.

As described previously, different gain ranges can be selected and used for different targets within the same FoV. Closer targets within the point cloud can be provided with one range with a lower slope and magnitude values to obtain optimal resolution of the closer targets, while at the same time farther targets within the point cloud can be provided with one or more different gain ranges with higher slopes and/or different magnitude values to obtain optimal resolution of the farther targets.
It can now be understood that various embodiments provide a LiDAR system with the capability of emitting light pulses over a selected FoV, along with a specially configured servo system which enhances beam resolution to selected areas of interest based on detected changes in environmental conditions. In this way, a region of interest can be identified based on various inputs (including automated inputs or user selected inputs) and greater focus is applied to the region(s) of interest in detecting range information for target(s) that may appear in such regions of interest. Any number of different alternatives will readily occur to the skilled artisan in view of the foregoing discussion.

While coherent, I/Q based systems have been contemplated as a basic environment in which various embodiments can be practiced, such are not necessarily required. Any number of different types of systems can be employed, including solid state, mechanical, micromirror technology, etc.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A method for detecting targets using a LiDAR system, comprising:
generating an illumination profile that identifies a portion of a field of view (FoV) to which enhanced electromagnetic radiation is to be applied by an emitter of the LiDAR system;
generating a scan profile corresponding to the illumination profile; and
applying the scan profile to an output device of the emitter to produce the selected illumination profile upon targets in the FoV so that a first region within the FoV has a higher first beam density and a second region within the FoV has a lower second beam density.

2. The method of claim 1, wherein the scan profile is generated responsive to an external sensor that indicates a change in operational environment for the LiDAR system.

3. The method of claim 1, wherein a servo control circuit provides a positional control input to the output device responsive to the scan profile to respectively provide a first rasterizing scanning pattern of the first region and a different, second rasterizing scanning pattern of the second region.

4. The method of claim 1, wherein the illumination profile is generated responsive to detection of a curved direction of travel of a vehicle in which the LiDAR system is mounted, and wherein the scan profile provides the higher first beam density to the first region within the FoV located in a direction of the curved direction of travel.

5. The method of claim 1, wherein the illumination profile is generated responsive to detection of a change in elevation of travel of a vehicle in which the LiDAR system is mounted, and wherein the scan profile provides the higher first beam density to the first region within the FoV located in a direction associated with the change in elevation of travel of the vehicle.

6. The method of claim 1, wherein the illumination profile is selected responsive to a detected target within the FoV, and the higher first beam density in the first region within the FoV is adaptively modified to track movement of the detected target within the FoV.

7. The method of claim 1, wherein the illumination profile is selected responsive to detection of a road marking associated with a path of travel of a vehicle in which the LiDAR system is mounted.

8. The method of claim 1, wherein the illumination profile is selected responsive to a geoposition input supplied by an external sensor.

9. The method of claim 1, wherein the scan profile is generated responsive to a plant model of a closed loop servo control response characteristic of the output system.

10. The method of claim 1, wherein the scan profile is adaptively changed to accommodate changes in elevation of a vehicle over a hill or a dip in a road along which a vehicle in which the LiDAR system is mounted is traveling.

11. The method of claim 1, wherein the output system comprises at least a selected one of a solid-state array, a rotatable polygon or a micromirror device to controllably direct a light beam from the emitter over the FoV.

12. The method of claim 1, wherein the first region is rasterized by a sequence of beam points of the electromagnetic radiation in the form of light pulses along orthogonal directions in a first rasterizing pattern, and wherein the second region is rasterized by a sequence of beam points of the electromagnetic radiation in the form of light pulses along orthogonal directions in a second rasterizing pattern.

13. The method of claim 12, wherein the first region is rasterized at a more frequent first frame rate and the second region is rasterized at a less frequent second frame rate.

14. The method of claim 12, wherein the light pulses in the first rasterizing pattern are each provided with a first waveform characteristic and the light pulses in the second rasterizing pattern are each provided with a different, second waveform characteristic.

15. An apparatus comprising:
an emitter of a LiDAR system configured to emit light pulses at a first resolution within a baseline, first field of view (FoV);
a servo control circuit configured to, responsive to an external input signal, select a region of interest within the first FoV and provide positional control signals to an output device of the emitter to concurrently scan the region of interest within the first FoV with a higher, second resolution, the external input signal supplied by an external sensor that indicates a change in operational environment for the apparatus.

16. The apparatus of claim 15, wherein the servo control circuit comprises a plant model which models a closed loop response of the output device and an observer which estimates inputs to be supplied to the output device based on the plant model to scan a first region of interest within the FoV at a higher first beam density and a second region of interest within the FoV at a lower second beam density.

17. The apparatus of claim 15, wherein the external input signal comprises a sensor that senses a geoposition of a vehicle in which the apparatus is mounted, and wherein the region of interest within the FoV is selected responsive to a change in the geoposition detected by the sensor.

18. The apparatus of claim 17, wherein the change in the geoposition indicates a change in elevation of the vehicle and the region of interest within the FoV is selected responsive to the indicated change in elevation.

19. The apparatus of claim 17, wherein the change in the geoposition indicates a change in direction of the vehicle and the region of interest within the FoV is selected responsive to the indicated change in direction.

20. The apparatus of claim 15, wherein the output device comprises at least a selected one of a rotatable polygon, a solid-state array device or a micromirror device.
